(19) United States
(12) Patent Application Publication
(10) Pub. No.: US 2025/0379421 A1
(43) Pub. Date: Dec. 11, 2025

(54) ROUTING BOARD AND ELECTRICAL CONNECTION UNIT

(71) Applicant: YAZAKI CORPORATION, Tokyo (JP)

(72) Inventors: Ryu Senoo, Kakegawa-shi (JP); Hirotaka Mukasa, Kakegawa-shi (JP); Hirokuni Kurashiki, Susono-shi (JP)

(21) Appl. No.: 19/218,210

(22) Filed: May 23, 2025

(30) Foreign Application Priority Data
Jun. 5, 2024 (JP) 2024-091496

(51) Int. Cl. H02B 1/20; H01R 25/16; H02B 1/24; H02B 1/56

(52) U.S. Cl. CPC H02B 1/20; H01R 25/161; H02B 1/24; H02B 1/56

(57) ABSTRACT

A routing board includes a first bus bar at least partially extending in a plate shape, a second bus bar located on the same plane as the first bus bar, disposed away from the first bus bar in a first direction, and at least partially extending in a plate shape, a first insulating member in contact with the first bus bar and the second bus bar from a second direction intersecting the first direction, a first cover portion that is a sheet-shaped member and is in contact with the first bus bar from a side opposite to the first insulating member, a second cover portion in contact with the second bus bar from the side opposite to the first insulating member, and a first bent portion bent from the first cover portion and the second cover portion toward the first insulating member.

### BACKGROUND OF THE INVENTION

### Field of the Invention

Embodiments of the present invention relate to a routing board and an electrical connection unit.

Priority is claimed on Japanese Patent Application No. 2024-091496 filed in Japan on Jun. 5, 2024, the content of which is incorporated herein by reference.

### Description of the Related Art

An electrical connection unit having a housing that accommodates electronic components and a bus bar attached to the housing in a standing posture is known.

### PRIOR ART DOCUMENT

### Patent Document

Patent Document 1: Japanese Unexamined Patent Application, First Publication No. 2024-037492

### SUMMARY OF THE INVENTION

Incidentally, a height of an electrical connection unit is expected to be further reduced.

An embodiment provides a routing board capable of reducing the height.

A routing board according to an embodiment includes a first bus bar, a second bus bar, a first insulating member, and a second insulating member. At least part of the first bus bar extends in a plate shape. The second bus bar is located on the same plane as the first bus bar and is disposed away from the first bus bar in a first direction. At least part of the second bus bar extends in a plate shape. The first insulating member is in contact with the first bus bar and the second bus bar from a second direction intersecting the first direction. The second insulating member is a sheet-shaped member, and includes a first cover portion, a second cover portion, and a first bent portion. The first cover portion is in contact with the first bus bar from a side opposite to the first insulating member. The second cover portion is in contact with the second bus bar from the side opposite to the first insulating member. The first bent portion is bent from the first cover portion and the second cover portion toward the first insulating member in a region between the first cover portion and the second cover portion and is joined to the first insulating member.

According to one embodiment, the height of an electrical connection unit can be reduced.

### BRIEF DESCRIPTION OF THE DRAWINGS

FIG. 1 is a cross-sectional view illustrating an electrical connection unit according to an embodiment;

FIG. 2 is a perspective view for describing a main body of the embodiment;

FIG. 3 is a perspective view for describing a subunit of the embodiment;

FIG. 4 is a partially exploded perspective view of the subunit of the embodiment;

FIG. 5 is a perspective view for describing an electronic component and a connection component according to the embodiment;

FIG. 6 is a perspective view for describing the electronic component and the connection component according to the embodiment;

FIG. 7 is a perspective view illustrating the connection component according to the embodiment;

FIG. 8 is a perspective view illustrating a routing board of the embodiment;

FIG. 9 is a cross-sectional view taken along line F9-F9 of the routing board illustrated in FIG. 8;

FIG. 10 is a cross-sectional view taken along line F9-F9 of the routing board illustrated in FIG. 8;

FIG. 11 is a cross-sectional view illustrating a modification example of the embodiment;

FIG. 12 is a plan view illustrating the routing board according to the embodiment;

FIG. 13 is a cross-sectional view taken along line F13-F13 of the structure illustrated in FIG. 12;

FIG. 14 is a partially exploded perspective view of the electrical connection unit according to the embodiment;

FIG. 15 is a cross-sectional view illustrating a modification example of the embodiment; and

FIG. 16 is a cross-sectional view illustrating a modification example of the embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. Note that the constitution described below does not limit the scope of the embodiment.

In the present disclosure, the terms are defined as follows. The term “connection” is not limited to a mechanical connection, and may include an electrical connection. That is, the term “connection” is not limited to a case where two elements that are connection targets are directly connected, and may include a case where two elements that are connection targets are connected with another element interposed therebetween. The term “accommodation” is not limited to a case where the entire component is accommodated, and may include a case where only part of the component is accommodated (a state in which the remaining part of the component protrudes). The term “facing” indicates that virtual projection images of two target objects overlap each other when viewed from a specific direction. That is, the term “facing” is not limited to a case where two target objects directly face each other, and may include a case where two target objects face each other in a state in which another member exists between the two target objects. “Parallel”, “orthogonal”, or “the same” may include “substantially parallel”, “substantially orthogonal”, or “substantially the same”, respectively.

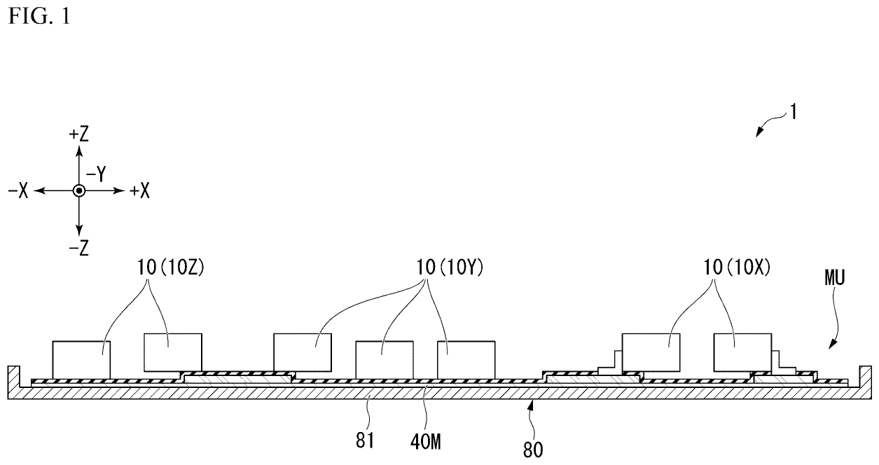

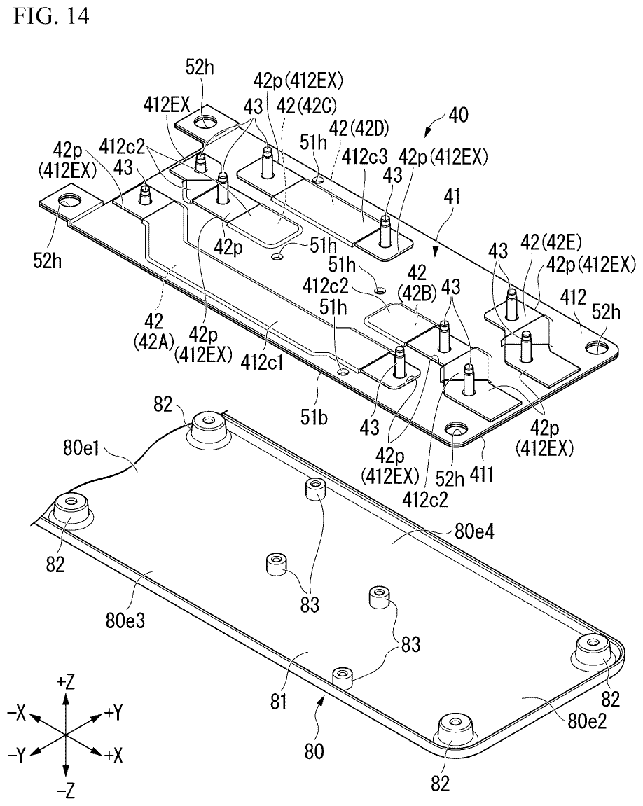

In the present disclosure, a +X direction, a-X direction, a +Y direction, a −Y direction, a +Z direction, and a-Z direction are defined as follows. The +X direction is a direction from a central portion 80e1 to a second end 80e2 of a plate 80 that will be described later (see FIG. 14). The −X direction is a direction opposite to the +X direction. Hereinafter, in a case where the +X direction and the −X direction are not distinguished, the directions will be simply referred to as “X direction”. The +Y direction and the −Y direction are directions intersecting (for example, orthogonal to) the X direction. The +Y direction is a direction from a third end 80e3 to a fourth end 80e4 of the plate 80 that will be described later (see FIG. 14). The −Y direction is a direction opposite to the +Y direction. Hereinafter, in a case where the +Y direction and the −Y direction are not distinguished, the directions will be simply referred to as “Y direction”. The +Z direction and the −Z direction are directions intersecting (for example, orthogonal to) the X direction and the Y direction. The +Z direction is a direction from the plate 80 that will be described later toward a main body MU (see FIG. 1). The −Z direction is a direction opposite to the +Z direction. Hereinafter, in a case where the +Z direction and the −Z direction are not distinguished, the directions will be simply referred to as “Z direction”.

The X direction is an example of a “first direction”. The Y direction is an example of a “second direction”. The “second direction” is not limited to the Y direction, and may be the X direction or other directions.

Hereinafter, in a case where the X direction and the Y direction are not distinguished, the directions may be referred to as “horizontal direction”. Hereinafter, the Z direction may be referred to as “vertical direction”. Hereinafter, the +Z direction side may be referred to as “upper”, and the −Z direction side may be referred to as “lower”. However, these expressions are expressions for convenience of description, and do not limit a gravity direction of an electrical connection unit 1 (an installation posture of the electrical connection unit 1).

### First Embodiment

### <1. Constitution of Electrical Connection Unit>

FIG. 1 is a cross-sectional view illustrating an electrical connection unit 1 of a first embodiment. The electrical connection unit 1 is, for example, an in-vehicle device mounted on a vehicle such as an electric vehicle (EV), a hybrid electric vehicle (HEV), or a plug-in hybrid electric vehicle (PHEV). The electrical connection unit 1 may be referred to as an “electrical connection box” or a “junction box”, for example. However, the electrical connection unit 1 is not limited to a box-shaped device.

The electrical connection unit 1 includes, for example, a main body MU and a plate 80.

### <2. Main Body>

First, the main body MU will be described.

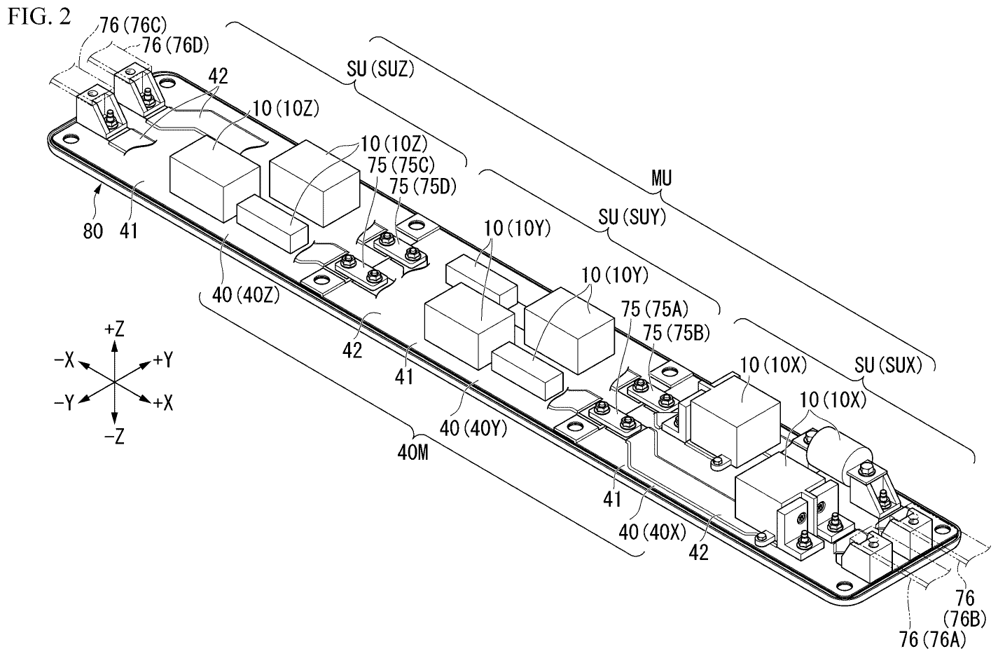

FIG. 2 is a perspective view for describing the main body MU. The main body MU is a portion that performs a main function (for example, switching of electrical connection states or overcurrent protection) of the electrical connection unit 1. In the present embodiment, the main body MU is divided into a plurality of subunits SU. The main body MU is formed by connecting a plurality of subunits SU. In the present embodiment, the main body MU includes three subunits SU (subunits SUX, SUY, and SUZ). Each subunit SU may be referred to as a “circuit constitution body”.

The subunit SUX has an electrical first function. The subunit SUX includes, for example, a plurality of electronic components 10X and a first routing board 40X. The plurality of electronic components 10X are electrically connected to the first routing board 40X.

The subunit SUY has an electrical second function. The second function is a function different from the first function. The subunit SUY includes, for example, a plurality of electronic components 10Y and a second routing board 40Y. The plurality of electronic components 10Y are electrically connected to the second routing board 40Y.

The subunit SUZ has an electrical third function. The third function is a function different from the first function and the second function. The subunit SUZ includes, for example, a plurality of electronic components 10Z and a third routing board 40Z. The plurality of electronic components 10Z are electrically connected to the third routing board 40Z.

In the present embodiment, the three subunits SUX, SUY, and SUZ are disposed to be arranged in the X direction. For example, the subunit SUX is disposed on the +X direction side with respect to the subunit SUY. The subunit SUX and the subunit SUY are electrically connected via a plurality of coupling bus bars 75 extending between the first routing board 40X and the second routing board 40Y. On the other hand, the subunit SUZ is disposed on the −X direction side with respect to the subunit SUY. The subunit SUZ and the subunit SUY are electrically connected via a plurality of coupling bus bars 75 extending between the third routing board 40Z and the second routing board 40Y. The coupling bus bar 75 is disposed on the side opposite to the plate 80 with respect to the plurality of subunits SU.

In the present embodiment, the three routing boards 40X, 40Y, and 40Z included in the three subunits SUX, SUY, and SUZ are disposed on the same plane. In other words, the three routing boards 40X, 40Y, and 40Z are disposed at the same height position in the Z direction. As a result, one large routing board 40M is formed by the three routing boards 40X, 40Y, and 40Z.

In the present embodiment, the three subunits SUX, SUY, and SUZ have the same or similar basic structure. Therefore, one subunit SU will be described in detail below as a representative. Hereinafter, in a case where the subunit SUX, the subunit SUY, and the subunit SUZ are not distinguished, the subunits are simply referred to as “subunit SU”. In addition, in a case where the electronic component 10X, the electronic component 10Y, and the electronic component 10Z are not distinguished, the electronic components are simply referred to as “electronic component 10”. In a case where the first routing board 40X, the second routing board 40Y, and the third routing board 40Z are not distinguished, the routing boards are simply referred to as “routing board 40”. One subunit SU included in the three subunits SUX, SUY, and SUZ is an example of a “first subunit”. On the other hand, another subunit SU included in the three subunits SUX, SUY, and SUZ is an example of a “second subunit”.

Note that the main body MU need not be divided into a plurality of subunits SU instead of the example described above. That is, the main body MU may be formed by the plurality of electronic components 10 and one routing board 40. In addition, the two or more subunits SU are not limited to the subunits SU having different functions, and may be the subunits SU having the same function.

### <3. Constitution of Subunit>

Next, a constitution of the subunit SU will be described.

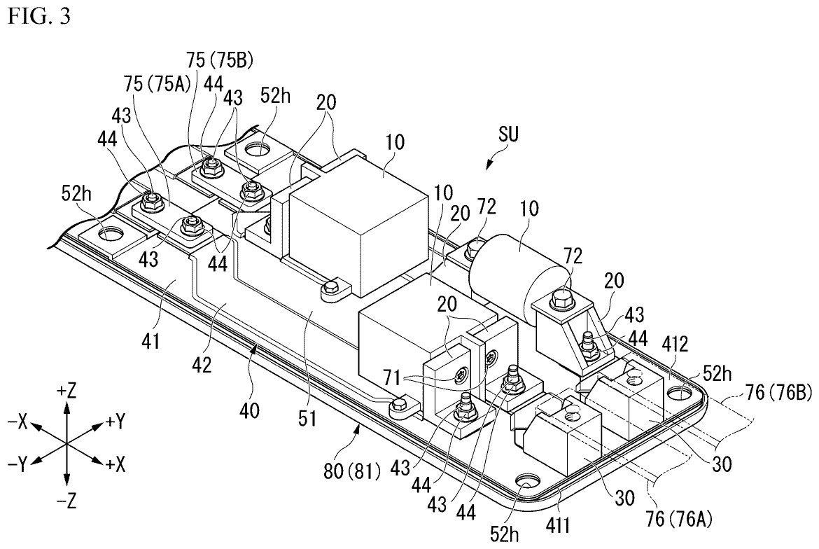

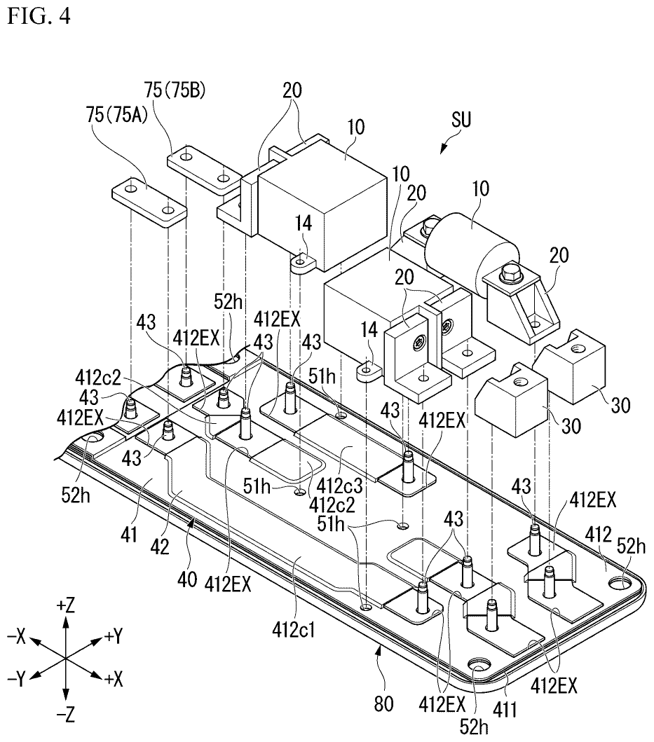

FIG. 3 is a perspective view for describing the subunit SU. FIG. 4 is a partially exploded perspective view of the subunit SU. The subunit SU includes, for example, a plurality of electronic components 10, a plurality of connection components 20 for component connection, a plurality of connection components 30 for external connection, and a routing board 40. The connection components 20 and 30 are members forming an energization path in the vertical direction. The connection components 20 and 30 may be referred to as “vertical routing members”.

### <3.1 Electronic Component and Connection Component for Component Connection>

First, the electronic component 10 and the connection component 20 for component connection will be described.

The electronic component 10 is an electronic component mounted according to a function required for the subunit SU. The electronic component 10 is, for example, a connector, a fuse, a relay (for example, a mechanical relay or a semiconductor relay), a capacitor, a branch component, any of various sensors (for example, a current sensor or a voltage sensor), an electronic control unit, or an electronic component unit in which two or more of these are unitized. Note that the type of the electronic component 10 is not limited to the above example. The electronic component 10 is, for example, a heat generating component that generates heat at the time of energization. Hereinafter, a first-type electronic component 10M and a second-type electronic component 10N will be described as examples of the electronic component 10.

The connection component 20 is a component that electrically connects the electronic component 10 to the routing board 40. The connection component 20 forms part of an energization path in the subunit SU. The connection component 20 is made of a metal (for example, copper or a copper alloy). The connection component 20 may be referred to as a “metal component”. Hereinafter, a first-type connection component 20M and a second-type connection component 20N will be described as examples of the connection component 20.

### <3.1.1 First-Type Electronic Component>

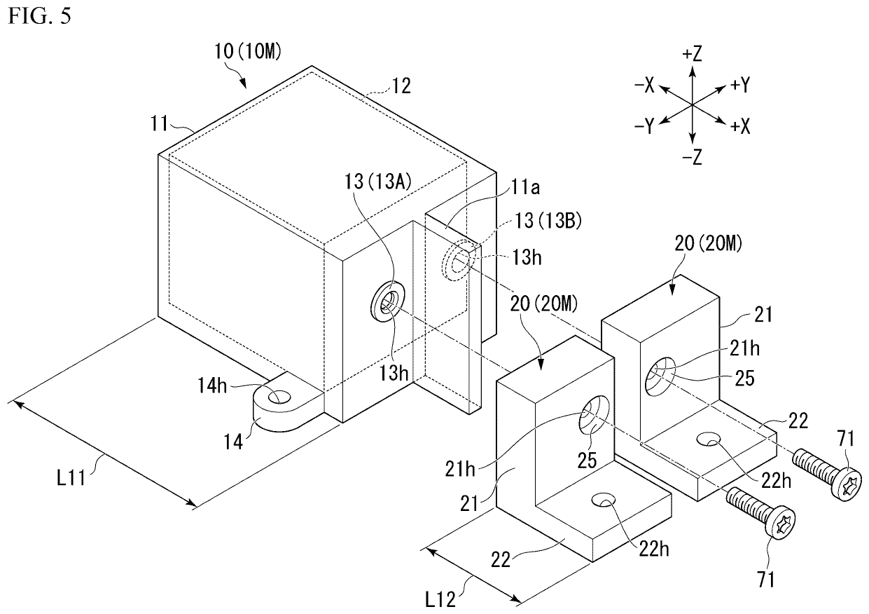

FIG. 5 is a perspective view illustrating the first-type electronic component 10M and the first-type connection component 20M. The first-type electronic component 10M is an electronic component in which a plurality of terminals 13 are disposed to be arranged at one end of the electronic component 10M. The electronic component 10M includes, for example, a case 11, a component body 12, a plurality of terminals 13, and a plurality of attachment portions 14.

### (Case)

The case 11 is an outer member that forms most of the outer shape of the electronic component 10M. The case 11 is made of, for example, synthetic resin and has an insulating property. The case 11 accommodates the component body 12. The case 11 and the component body 12 may be integrally formed.

In the present embodiment, the case 11 has an insulating rib 11a that protrudes in the horizontal direction (for example, the X direction) and extends in the Z direction. The insulating rib 11a has, for example, a plate shape formed in the horizontal direction (for example, the X direction) and the Z direction. The insulating rib 11a extends over the entire length of the case 11 in the Z direction, for example. The insulating rib 11a is disposed between the plurality of terminals 13 (a terminal 13A and a terminal 13B that will be described later). The insulating rib 11a electrically insulates the terminal 13A from the terminal 13B. In the present embodiment, part of the insulating rib 11a is disposed between first portions 21 (that will be described later) of two connection components 20M connected to the electronic component 10M. The insulating rib 11a electrically insulates the first portions 21 of the two connection components 20M connected to the electronic component 10M from each other.

### (Component Body)

The component body 12 is a portion that performs a main function of the electronic component 10M. For example, in a case where the electronic component 10M is a relay, the component body 12 includes a switch (for example, a contact) that switches between a conductive state and a non-conductive state. For example, in a case where the electronic component 10M is a fuse, the component body 12 includes a fusion portion that is fused when an overcurrent flows. For example, in a case where the electronic component 10M is a capacitor, the component body 12 includes a portion that stores electric charge.

### (Terminal)

The terminal 13 is an electrical connection portion exposed to the outside of the case 11. The terminal 13 is electrically connected to the component body 12 inside the case 11. In the present embodiment, the electronic component 10M includes a terminal 13A and a terminal 13B as the plurality of terminals 13. One of the terminal 13A and the terminal 13B is a terminal on the positive electrode side. The other of the terminal 13A and the terminal 13B is a terminal on the negative electrode side. One of the terminal 13A and the terminal 13B is an example of a “first terminal”. The other of the terminal 13A and the terminal 13B is an example of a “second terminal”.

In the present embodiment, the terminal 13A and the terminal 13B are provided at one end of the electronic component 10M in the horizontal direction (for example, the X direction). The terminal 13A and the terminal 13B are disposed to be arranged in the horizontal direction (for example, the Y direction). Each terminal 13 has an attachment hole 13h to which a fastening member 71 (for example, a screw or a bolt) that will be described later is attached. The attachment hole 13h is open in the horizontal direction (for example, the X direction). An inner circumferential surface of the attachment hole 13h of the electronic component 10M has a screw groove.

### (Attachment Portion)

The attachment portion 14 is a portion for fixing the electronic component 10M in a case where a protrusion 83 corresponding to a through-hole 51h that will be described later or a through-hole is present. For example, the attachment portion 14 has an attachment hole 14h to which a fastening member (for example, a screw or a bolt) is attached. The attachment hole 14h is open in the Z direction. The attachment hole 14h is an insertion hole through which a fastening member or the protrusion 83 passes.

### <3.1.2 First-Type Connection Component>

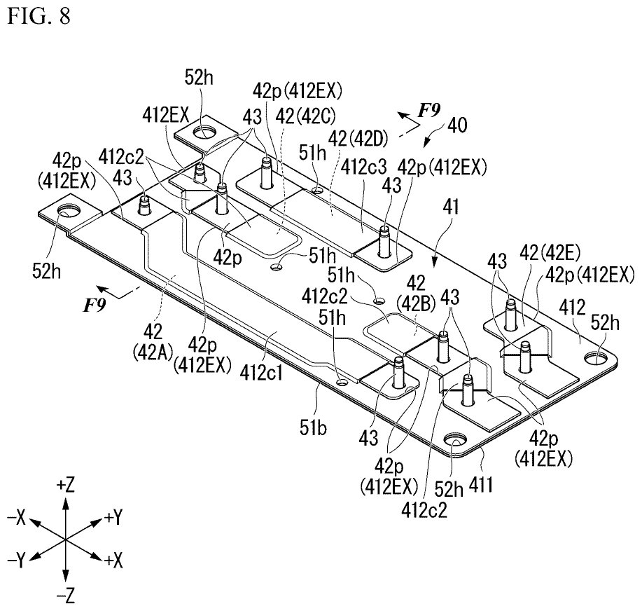

The first-type connection component 20M is a component that electrically connects the first-type electronic component 10M to the routing board 40. In the present embodiment, the connection component 20M electrically connects the electronic component 10M to a bus bar 42 (see FIG. 8) included in the routing board 40. In the present embodiment, a width L12 of the connection component 20M in a longitudinal direction (for example, the X direction) of the electronic component 10M is smaller than a width L11 of the electronic component 10M in the longitudinal direction. The connection component 20M includes, for example, a first portion 21 and a second portion 22.

### (First Portion)

The first portion 21 of the connection component 20M is a portion connected to the terminal 13 of the electronic component 10M. The first portion 21 is a plate-shaped or rectangular parallelepiped portion extending in the Z direction. The first portion 21 extends in the Z direction along one end (for example, an end in the X direction) of the electronic component 10M. The first portion 21 is a standing portion that stands in the Z direction with respect to the routing board 40 (for example, with respect to a bus bar 42 that will be described later). The first portion 21 is adjacent to the electronic component 10M in the horizontal direction (for example, the X direction). For example, the first portion 21 is adjacent to the terminal 13 of the electronic component 10M in the horizontal direction (for example, the X direction), and is connected to the terminal 13 of the electronic component 10M from the horizontal direction (for example, the X direction).

The first portion 21 of the connection component 20M has a first attachment hole 21h through which the fastening member 71 (for example, a screw or a bolt) passes. The first attachment hole 21h is open in the horizontal direction (for example, the X direction). The first portion 21 has a recess 25 around the first attachment hole 21h. The recess 25 is an accommodation portion that accommodates a head of the fastening member 71 inserted into the first attachment hole 21h. The fastening member 71 that has passed through the first attachment hole 21h is engaged with the attachment hole 13h of the terminal 13 of the electronic component 10M, and thus the first portion 21 is physically and electrically connected to the terminal 13 of the electronic component 10M. The first portion 21 need not have the recess 25.

### (Second Portion)

The second portion 22 of the connection component 20M is a portion connected to the bus bar 42 (see FIG. 8). The second portion 22 protrudes in the horizontal direction (for example, the X direction) from end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20M is attached to the fastening member 43 (for example, a screw or a bolt; and see FIG. 8) protruding from the bus bar 42 in the +Z direction from the Z direction, and is physically and electrically connected to the bus bar 42. In the present embodiment, the second portion 22 of the connection component 20M has a second attachment hole 22h through which the fastening member 43 passes. The second attachment hole 22h is open in the Z direction. In the second portion 22, the fastening member 43 passes through the second attachment hole 22h. An engagement member 44 (for example, a nut; and see FIG. 3) is engaged with the tip of the fastening member 43 that has passed through the second attachment hole 22h, and thus the second portion 22 is fixed to the bus bar 42. In the present embodiment, the first portion 21 and the second portion 22 form one L-shaped connection component 20M.

### <3.1.3 Second-Type Electronic Component>

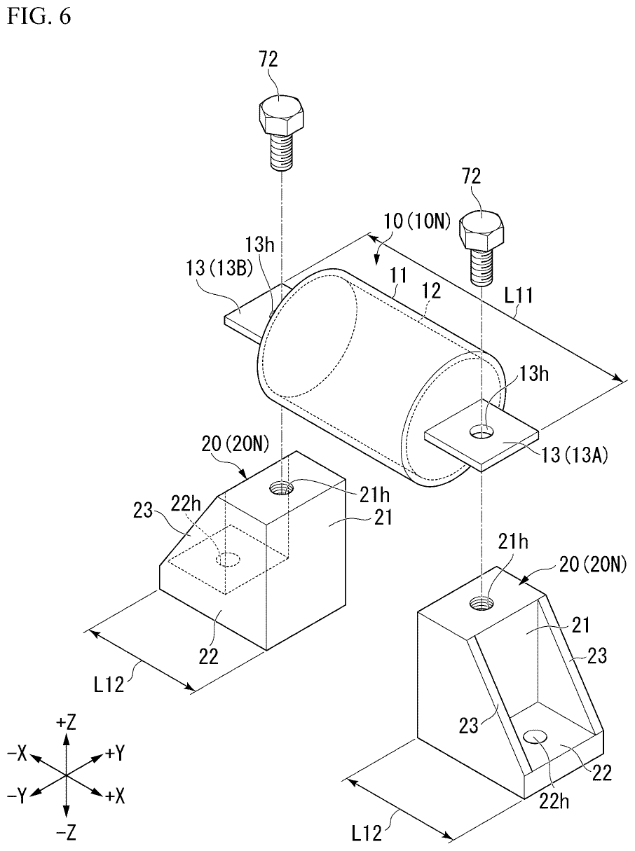

FIG. 6 is a perspective view illustrating the second-type electronic component 10N and the second-type connection component 20N. The second-type electronic component 10N is an electronic component in which two terminals 13 are separately disposed at both ends in the horizontal direction of the electronic component 10N. The electronic component 10N includes, for example, a case 11, a component body 12, and a plurality of terminals 13. Note that, among the constitutions of the electronic component 10N, constitutions having functions similar to those of the electronic component 10M are denoted by the same reference numbers. In this case, in the description regarding the electronic component 10N, the “electronic component 10M” may be replaced with the “electronic component 10N” in the description regarding the electronic component 10M described above.

In the electronic component 10N, the terminal 13A and the terminal 13B are disposed separately at both ends of the electronic component 10N in the horizontal direction (for example, the X direction). Each terminal 13 has an attachment hole 13h to which a fastening member 72 (for example, a screw or a bolt) that will be described later is attached. The attachment hole 13h is open in the Z direction. For example, the attachment hole 13h of the electronic component 10N is an insertion hole through which the fastening member 72 passes. One of the terminal 13A and the terminal 13B is an example of a “first terminal”. The other of the terminal 13A and the terminal 13B is an example of a “second terminal”.

### <3.1.4 Second-Type Connection Component>

The second-type connection component 20N is a component that electrically connects the second-type electronic component 10N to the routing board 40. In the present embodiment, the connection component 20N electrically connects the electronic component 10N to the bus bar 42 (see FIG. 8) included in the routing board 40. In the present embodiment, a width L12 of the connection component 20N in the longitudinal direction (for example, the X direction) of the electronic component 10N is smaller than a width L11 of the electronic component 10N in the longitudinal direction. The connection component 20N includes, for example, a first portion 21, a second portion 22, and a third portion 23.

### (First Portion)

The first portion 21 of the connection component 20N is a portion connected to the terminal 13 of the electronic component 10N. The first portion 21 is a rectangular parallelepiped portion extending in the Z direction. The first portion 21 is a standing portion that stands in the Z direction with respect to the routing board 40 (for example, with respect to the bus bar 42). The first portion 21 is adjacent to the terminal 13 of the electronic component 10N in the Z direction, and is connected to the terminal 13 of the electronic component 10N from the Z direction. The first portion 21 of the connection component 20N has a first attachment hole 21h with which the fastening member 72 is engaged. The first attachment hole 21h is open in the Z direction. An inner circumferential surface of the first attachment hole 21h of the connection component 20N has a screw groove. The fastening member 72 that has passed through the attachment hole 13h of the terminal 13 of the electronic component 10N is engaged with the first attachment hole 21h of the first portion 21, and thus the first portion 21 is physically and electrically connected to the terminal 13 of the electronic component 10N.

### (Second Portion)

The second portion 22 of the connection component 20N is a portion connected to the bus bar 42 (see FIG. 8). The second portion 22 protrudes in the horizontal direction (for example, the X direction) from end of the first portion 21 on the −Z direction side. The second portion 22 is a plate portion provided in the horizontal direction. The second portion 22 is adjacent to the bus bar 42 in the Z direction, and is connected to the bus bar 42 from the Z direction. The second portion 22 of the connection component 20N is attached to, from the Z direction, the fastening member 43 (for example, a screw or a bolt; and see FIG. 8) protruding from the bus bar 42 in the +Z direction, and is physically and electrically connected to the bus bar 42. In the present embodiment, the second portion 22 of the connection component 20N has a second attachment hole 22h through which the fastening member 43 passes. The second attachment hole 22h is open in the Z direction. In the second portion 22, the fastening member 43 that will be described later passes through the second attachment hole 22h. An engagement member 44 (for example, a nut; and see FIG. 3) is engaged with the tip of the fastening member 43 that has passed through the second attachment hole 22h, and thus the second portion 22 is fixed to the bus bar 42.

### (Third Portion)

The third portion 23 is a standing wall (side wall) standing in the +Z direction from both ends of the second portion 22 in the horizontal direction. The third portion 23 is a wall provided in the Z direction. The third portion 23 is connected to the first portion 21 and is also connected to the second portion 22. For example, the third portion 23 extends obliquely so as to increase in the X direction as proceeding in the −Z direction. The third portion 23 may be provided in the connection component 20M described above. On the other hand, the connection component 20N need not have the third portion 23.

### <3.2 Connection Component for External Connection>

Next, the connection component 30 for external connection will be described.

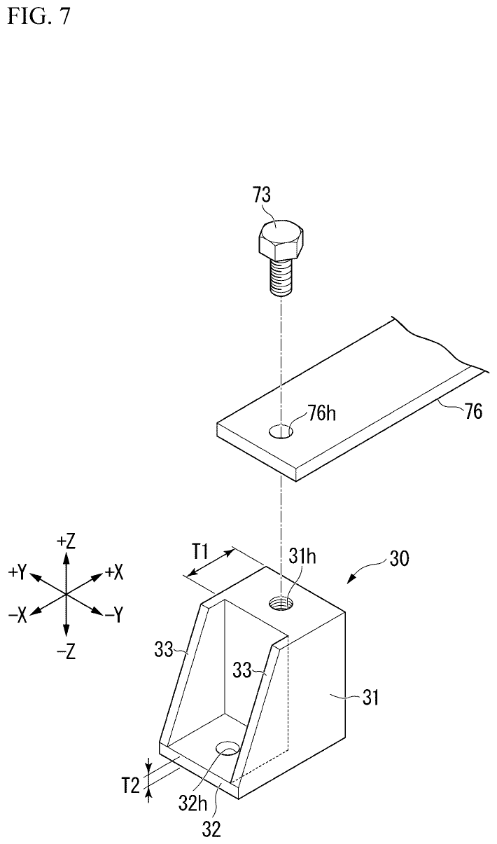

FIG. 7 is a perspective view illustrating the connection component 30 for external connection. The connection component 30 is a component that electrically connects an external connection bus bar 76 to the routing board 40. In the present embodiment, the connection component 30 electrically connects the external connection bus bar 76 to the bus bar 42 (see FIG. 8) included in the routing board 40. The external connection bus bar 76 is electrically connected to an external device. In the present disclosure, the “external device” is an electrical device existing outside the electrical connection unit 1. The external device is, for example, a battery unit mounted on a vehicle or an inverter for driving a motor of the vehicle, but is not limited to these examples. The connection component 30 includes, for example, a first portion 31, a second portion 32, and a third portion 33.

### (First Portion)

The first portion 31 is a portion connected to the external connection bus bar 76. The first portion 31 is a rectangular parallelepiped portion extending in the Z direction. The first portion 31 is a standing portion that stands in the Z direction with respect to the routing board 40 (for example, with respect to the bus bar 42). The first portion 31 is adjacent to the external connection bus bar 76 in the Z direction, and is connected to the external connection bus bar 76 from the Z direction. The first portion 31 has a first attachment hole 31h through which a fastening member 73 (for example, a screw or a bolt) passes. The first attachment hole 31h is open in the Z direction. An inner circumferential surface of the first attachment hole 31h has a screw groove. The fastening member 73 that has passed through the attachment hole 76h of the external connection bus bar 76 is engaged with the first attachment hole 31h of the first portion 31, and thus the first portion 31 is physically and electrically connected to the external connection bus bar 76.

### (Second Portion)

The second portion 32 is a portion connected to the bus bar 42 (see FIG. 8). The second portion 32 protrudes in the horizontal direction (for example, the X direction) from the end of the first portion 31 on the −Z direction side. The second portion 32 is a plate portion provided in the horizontal direction. The second portion 32 is adjacent to the bus bar 42 in the Z direction, and is connected to the bus bar 42 from the Z direction. The second portion 32 is attached to, from the Z direction, the fastening member 43 (for example, a screw or a bolt; and see FIG. 8) protruding from the bus bar 42 in the +Z direction, and is physically and electrically connected to the bus bar 42. In the present embodiment, the second portion 32 has a second attachment hole 32h through which the fastening member 43 passes. The second attachment hole 32h is open in the Z direction. In the second portion 32, the fastening member 43 that will be described later passes through the second attachment hole 32h. The engagement member 44 (for example, a nut; and see FIG. 3) is engaged with the tip of the fastening member 43 that has passed through the second attachment hole 32h, and thus the second portion 32 is fixed to the bus bar 42.

### (Third Portion)

The third portion 33 is a standing wall (side wall) standing in the +Z direction from both ends of the second portion 32 in the horizontal direction. The third portion 33 is a wall provided in the Z direction. The third portion 33 is connected to the first portion 31 and is also connected to the second portion 32. For example, the third portion 33 extends obliquely to increase in the X direction (or the Y direction) as proceeding in the −Z direction. The connection component 30 need not include the third portion 33.

### <3.3 Routing Board>

Next, the routing board 40 will be described.

FIG. 8 is a perspective view illustrating the routing board 40. The routing board 40 is a member that forms at least part of an energization path between the plurality of electronic components 10 and/or at least part of an energization path between the electronic component 10 and an external device. In the present disclosure, the “routing board” refers to a board including a sheet-shaped insulating member. The “sheet-shaped” is not limited to a member having a thickness of 1 mm or more, and may include a member (for example, an insulating film) having a thickness of less than 1 mm. For example, the routing board 40 includes a first insulating member 411 and a sheet-shaped second insulating member 412. In the present embodiment, the first insulating member 411 and the second insulating member 412 are sheet-shaped members (insulating films). In the present embodiment, the routing board 40 is disposed along the X direction and the Y direction.

The routing board 40 includes, for example, a holding member 41, one or more (for example, a plurality of) bus bars 42, and a plurality of fastening members 43. In the present embodiment, the plurality of bus bars 42 are integrated by the first insulating member 411 and the second insulating member 412. For example, after the fastening member 43 is fixed to the bus bar 42, the bus bar 42 is integrated with the holding member 41 by the first insulating member 411 and the second insulating member 412, whereby the routing board 40 is formed as a single member. That is, the bus bar 42 is integrated with the holding member 41 without using a fastening member such as a screw or a bolt. A modification example of the routing board 40 will be described later.

### (Holding Member)

The holding member 41 integrally holds the plurality of bus bars 42 arranged in the horizontal direction at intervals. The holding member 41 includes the first insulating member 411 and the sheet-shaped second insulating member 412. Examples of the first insulating member 411 include a flexible insulating member such as an insulating sheet. The first insulating member 411 may be a hard synthetic resin member or the like. In addition, the present invention is not limited to the above member, and a plate-shaped member having an insulating property or a plate-shaped member to which an insulating property is separately added may be used. Examples of the second insulating member 412 include a flexible insulating member such as an insulating sheet.

The holding member 41 includes the first insulating member 411 and the second insulating member 412. The first insulating member 411 is in contact with the plurality of bus bars 42 from a second direction (Z direction) intersecting the first direction (X direction). In the present embodiment, the holding member 41 holds, for example, five bus bars 42A, 42B, 42C, 42D, 42E as the plurality of bus bars 42. The five bus bars 42A, 42B, 42C, 42D, and 42E are disposed to be arranged in the horizontal direction at intervals. The five bus bars 42A, 42B, 42C, 42D, and 42E include portions arranged on the same plane. The five bus bars 42A, 42B, 42C, 42D, and 42E are placed on a flat surface portion 51 of the first insulating member 411.

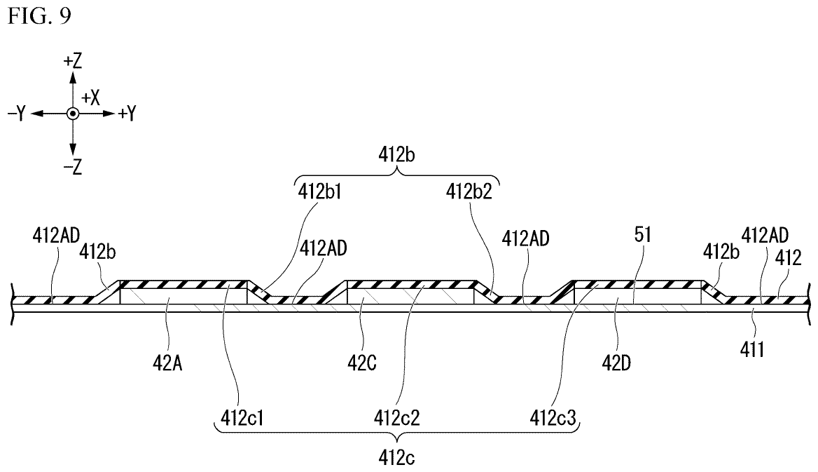

As illustrated in FIG. 9, the first insulating member 411 has the flat surface portion 51. The flat surface portion 51 is a region of the holding member 41 that is provided along the horizontal direction. The flat surface portion 51 forms a main portion of the holding member 41. The flat surface portion 51 forms a base portion of the holding member 41. In the present embodiment, the flat surface portion 51 is a plate portion along the X direction and the Y direction. Alternatively, the flat surface portion 51 may have an uneven shape along the outer shape of the plurality of bus bars 42. For example, the flat surface portion 51 may have a shape similar to the second insulating member 412.

The plurality of bus bars 42 are placed on the flat surface portion 51. The flat surface portion 51 has a through-hole 51h corresponding to the protrusion 83 of the plate 80 when viewed from the Z direction. The flat surface portion 51 has a through-hole 52h corresponding to the protrusion 82 of the plate 80 when viewed from the Z direction. The through-hole 51h and the through-hole 52h penetrate the flat surface portion 51 and the second insulating member 412 in the Z direction.

The protrusion 83 may be inserted into the through-hole 51h. The through-hole 51h may have a diameter that allows the protrusion 83 to be inserted. This is because it is conceivable to fix the routing board 40 through thermal caulking that will be described later.

Similarly, the protrusion 82 may be inserted into the through-hole 52h. The through-hole 52h may have a diameter that allows the protrusion 82 to be inserted.

As illustrated in FIG. 9, the second insulating member 412 includes a cover portion 412c and a bent portion 412b. In the present embodiment, the second insulating member 412 includes, as the cover portion 412c, a first cover portion 412c1, a second cover portion 412c2, and a third cover portion 412c3. In the present embodiment, the second insulating member 412 has a first bent portion 412b1 and a second bent portion 412b2 as the bent portion 412b. The second insulating member 412 is in contact with at least two bus bars 42.

The cover portion 412c is in contact with the bus bar 42 from the side opposite to the first insulating member 411. The first cover portion 412cl is in contact with the first bus bar from the side opposite to the first insulating member 411. The second cover portion 412c2 is in contact with the second bus bar from the side opposite to the first insulating member 411. The third cover portion 412c3 is in contact with the third bus bar from the side opposite to the first insulating member 411.

As illustrated in FIG. 9, the bent portion 412b has a joint portion 412AD. The first insulating member 411 and the second insulating member 412 are joined at the joint portion 412AD.

The bent portion 412b is bent from each cover portion 412c toward the first insulating member 411 in a region between the plurality of cover portions 412c and is joined to the first insulating member 411. The first bent portion 412b1 is bent from the first cover portion 412c1 and the second cover portion 412c2 toward the first insulating member 411 in a region between the first cover portion 412cl and the second cover portion 412c2 and is joined to the first insulating member 411. The second bent portion 412b2 is bent from the second cover portion 412c2 and the third cover portion 412c3 toward the first insulating member 411 in a region between the second cover portion 412c2 and the third cover portion 412c3 and is joined to the first insulating member 411. That is, the first insulating member 411 and the bent portion 412b are joined in the region between the bus bars 42. By joining in the region, the holding member 41 electrically insulates each bus bar 42.

The first insulating member 411 and the bent portion 412b may be joined through welding or bonding using an adhesive.

The first cover portion 412c1, the second cover portion 412c2, the third cover portion 412c3, the first bent portion 412b1, and the second bent portion 412b2 each extend in the X direction.

In addition, in part of the cover portion 412c, part of a contact location with the bus bar 42 may be exposed. In the present embodiment, parts of the first cover portion 412c1, the second cover portion 412c2, and the third cover portion 412c3 are exposed to the outside of the holding member 41. An opening 412EX is present in part of the second insulating member 412 exposed to the outside.

### (Bus Bar)

The bus bar 42 is a routing member (electrical connection member) included in the routing board 40. The bus bar 42 is, for example, a routing member for electrically connecting the plurality of electronic components 10. Alternatively, the bus bar 42 may be a routing member for connecting the electronic component 10 to an external device. The bus bar 42 is made of a metal (for example, copper or a copper alloy) and has conductivity.

The thickness of the bus bar 42 is 1 mm or more (for example, 3 mm or more) to 20 mm. In the extending direction of the bus bar 42, the electrical connection unit 1 is not bent.

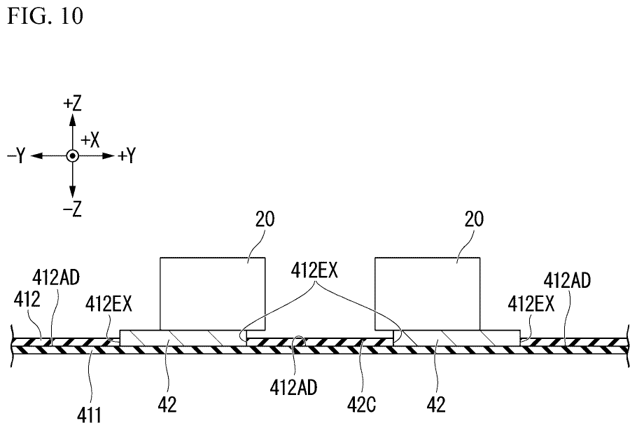

For example, as illustrated in FIG. 10, the height (thickness) of the second insulating member 412 in the second direction (Z direction) at the joint portion 412AD is less than the height (thickness) of the bus bar 42. Consequently, when the connection component 20 (connection component 30) is connected to the bus bar 42, the second insulating member 412 hardly pushes up the connection component 20 (connection component 30) in the second direction (Z direction). That is, the bus bar 42 and the connection component 20 (connection component 30) are easily connected, and the electrical connection of the electronic component 10 is easily secured.

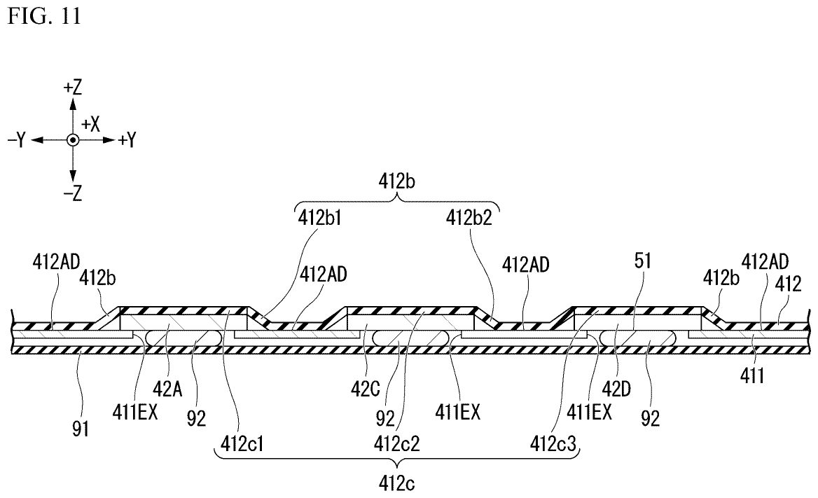

For example, as illustrated in FIG. 11, part of a contact location with the bus bar 42 may be exposed in part of the first insulating member 411. In the present embodiment, parts of the bus bar 42A, the bus bar 42C, and the bus bar 42D are exposed to the outside of the holding member 41. The opening 411EX is present in part of the first insulating member 411 exposed to the outside. In this case, the heat transfer member 92 may be disposed in contact with the bus bar 42 exposed at the opening 411EX. The heat transfer member 92 is a member for transferring heat generated by the electronic component 10 at the time of energization and/or heat (Joule heat) generated by the bus bar 42 itself at the time of energization to the plate 80. The heat transfer member 92 is, for example, a heat transfer sheet (for example, a thermally conductive silicone sheet) having elasticity. The heat transfer member 92 is made of a material having a thermal conductivity higher than that of the holding member 41, for example. However, the heat transfer member 92 is not limited to the above example, and may be a heat transfer member made of a thermally conductive gel or another material.

When the heat transfer member 92 is disposed, the insulating sheet 91 may be used. The insulating sheet 91 is an insulating member for electrically insulating the plate 80 from the bus bar 42 of each subunit SU. The insulating sheet 91 is made of, for example, a synthetic resin such as polyester or polyimide, and has an insulating property. The insulating sheet 91 has a rectangular shape when viewed from the Z direction. The insulating sheet 91 has a sheet shape formed in the horizontal direction. The insulating sheet 91 is disposed between the flat surface portion 81 of the plate 80 and the routing board 40 of each subunit SU. For example, the insulating sheet 91 is disposed between the flat surface portion 81 of the plate 80 and the plurality of heat transfer members 92. Note that, in a case where the heat transfer member 92 has an insulating property and the necessary insulating property is secured by the heat transfer member 92, the insulating sheet 91 may be omitted.

For example, as illustrated in FIG. 11, the height (thickness) of the first insulating member 411 in the second direction (Z direction) at the joint portion 412AD is less than the height (thickness) of the heat transfer member 92. This makes it difficult for the first insulating member 411 to push down the heat transfer member 92 in the second direction (Z direction) when the heat transfer member 92 is disposed in contact with the bus bar 42. That is, the bus bar 42 and the heat transfer member 92 are easily connected, and the bus bar 42 is easily cooled.

At least part of each bus bar 42 extends in a plate shape along the horizontal direction. Hereinafter, portion of each bus bar 42 extending in a plate shape along the horizontal direction may be referred to as a “plate portion 42p”. The bus bar 42 is a member that forms a horizontal energization path. The bus bar 42 may be referred to as a “horizontal routing member”.

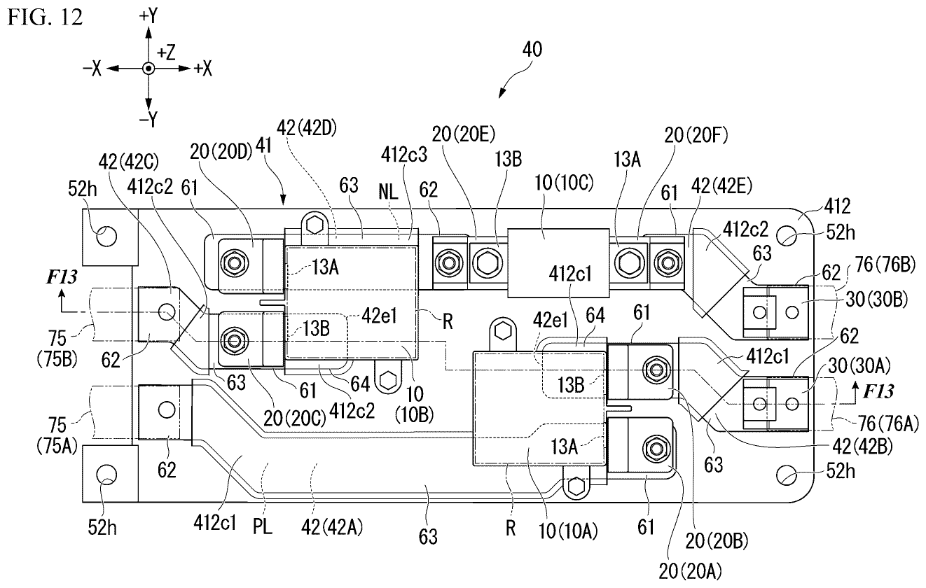

FIG. 12 is a plan view illustrating the routing board 40. The plate portion 42p of each bus bar 42 has, for example, a first connection portion 61, a second connection portion 62, and an extending portion 63.

The first connection portion 61 and the second connection portion 62 are exposed to the outside of the holding member 41 via the opening 412EX of the cover portion 41c. In the present embodiment, the first connection portion 61 and the second connection portion 62 protrude in the Z direction through the opening 412EX.

The first connection portion 61 is a portion in contact with one connection component 20 (hereinafter referred to as a “first connection component 20”). The first connection component 20 is a connection component that connects one electronic component 10 (hereinafter referred to as a “first electronic component 10”) to the bus bar 42. The first connection portion 61 is a portion of the bus bar 42 overlapping the first connection component 20 when viewed from the Z direction. The first connection portion 61 is adjacent to the first connection component 20 in the Z direction, and is connected to the first connection component 20 from the Z direction.

The second connection portion 62 is a portion in contact with another connection component 20 (hereinafter referred to as a “second connection component 20”). The second connection component 20 is a connection component that connects another electronic component 10 (hereinafter referred to as a “second electronic component 10”) included in the plurality of electronic components 10 to the bus bar 42. The second connection portion 62 is a portion of the bus bar 42 overlapping the second connection component 20 when viewed from the Z direction. The second connection portion 62 is adjacent to the second connection component 20 in the Z direction, and is connected to the second connection component 20 from the Z direction.

Note that the second connection portion 62 may be a portion in contact with another connection component 30 (hereinafter referred to as a “second connection component 30”) instead of the above example. The connection component 30 is a connection component for connecting an external device to the bus bar 42. In this case, the second connection portion 62 is a portion of the bus bar 42 overlapping the second connection component 30 when viewed from the Z direction. The second connection portion 62 is adjacent to the second connection component 30 in the Z direction, and is connected to the second connection component 30 from the Z direction.

The second connection portion 62 may be a portion in contact with the coupling bus bar 75 for connection with another subunit SU instead of the connection components 20 and 30. In this case, the second connection portion 62 is a portion of the bus bar 42 that overlaps the coupling bus bar 75 when viewed from the Z direction. The second connection portion 62 is adjacent to the coupling bus bar 75 in the Z direction, and is connected to the coupling bus bar 75 from the Z direction.

The extending portion 63 extends from the first connection portion 61 in the X direction or the Y direction. The extending portion 63 is provided between the first connection portion 61 and the second connection portion 62. The extending portion 63 extends over the first connection portion 61 and the second connection portion 62. The extending portion 63 connects the first connection portion 61 to the second connection portion 62.

In the present embodiment, the first connection portion 61, the second connection portion 62, and the extending portion 63 have a plate shape formed in the horizontal direction.

The extending portion 63 extends over a region R overlapping the electronic component 10 when viewed from the Z direction, over the +X direction side and the −X direction side of the region R. That is, the plurality of bus bars 42 are integrated by the second insulating member 412, and thus it is easy to route the plurality of bus bars in a better path (for example, a path with a shorter distance) without being disturbed by the presence of the electronic component 10.

The one or more bus bars 42 may have an extension 64 in addition to the first connection portion 61, the second connection portion 62, and the extending portion 63. The extension 64 is a portion where the bus bar 42 extends for the purpose of increasing a heat dissipation area and/or increasing a heat capacity for heat storage (heat absorption). The extension 64 is a portion that is not used for electrical connection. For example, the extension 64 is located on the side opposite to the extending portion 63 with respect to the first connection portion 61 (or the second connection portion 62). The extension 64 has a plate shape formed in the horizontal direction. The extension 64 is accommodated in the accommodation portion 55 and extends along the flat surface portion 51. The extension 64 extends to the region R overlapping the electronic component 10 when viewed from the Z direction, and has an end 42el of the bus bar 42 at a position overlapping the electronic component 10 when viewed from the Z direction.

Some routing examples of the bus bar 42 will be described below. The plurality of electronic components 10 include three electronic components 10A, 10B, and 10C. The electronic component 10A and the electronic component 10B are, for example, the first-type electronic component 10M. The electronic component 10C is, for example, the second-type electronic component 10N. Note that the type of the electronic component 10 is not limited to the above example. The plurality of connection components 20 include six connection components 20A, 20B, 20C, 20D, 20E, and 20F. The plurality of connection components 30 include two connection components 30A and 30B. The plurality of coupling bus bars 75 include four coupling bus bars 75A, 75B, 75C, and 75D. The plurality of external connection bus bars 76 include four external connection bus bars 76A, 76B, 76C, and 76D. In the present embodiment, the electrical connection unit 1 can be connected to a first external device via the external connection bus bars 76A and 76B, and can be connected to a second external device via the external connection bus bars 76C and 76D. The electrical connection unit 1 can be connected between the first external device and the second external device.

### (First Routing Example)

First, a routing example related to the bus bar 42A will be described. The bus bar 42A has the first connection portion 61, the second connection portion 62, and extending portion 63. The first connection portion 61 is located on the +X direction side with respect to the electronic component 10A when viewed from the Z direction. The first connection portion 61 is electrically connected to the terminal 13A of the electronic component 10A via the connection component 20A that is the first connection component 20. The second connection portion 62 is located on the −X direction side with respect to the electronic component 10A when viewed from the Z direction. The second connection portion 62 is electrically connected to another subunit SU via the coupling bus bar 75A.

The extending portion 63 extends over both sides of a region R through the region R overlapping the electronic component 10 when viewed from the Z direction. For example, the extending portion 63 extends linearly in the X direction. The extending portion 63 extends over the region R overlapping the electronic component 10A when viewed from the Z direction, over the +X direction side and the −X direction side of the region R. The bus bar 42A is an example of a “first bus bar”. The bus bar 42A is, for example, a bus bar included in the positive electrode line PL included in the electrical connection unit 1.

### (Second Routing Example)

Next, a routing example related to the bus bar 42B will be described. The bus bar 42B has the first connection portion 61, the second connection portion 62, the extending portion 63, and the extension 64. The first connection portion 61 is electrically connected to the terminal 13B of the electronic component 10A via the connection component 20B that is the first connection component 20. The second connection portion 62 is electrically connected to the external connection bus bar 76A via the connection component 30A that is the second connection component 30. The extension 64 extends to the region R overlapping the electronic component 10A when viewed from the Z direction, and has an end 42e1 of the bus bar 42 at a position overlapping the electronic component 10A. Similarly to the bus bar 42A, the bus bar 42B may have an extending portion 63 that extends through the region R overlapping the electronic component 10 and over both sides of the region R when viewed from the Z direction. The bus bar 42B is another example of a “first bus bar”. From another point of view, the bus bar 42B is an example of a “second bus bar”. The bus bar 42B is, for example, a bus bar included in the positive electrode line PL included in the electrical connection unit 1.

### (Third Routing Example)

Next, a routing example related to the bus bar 42C will be described. The bus bar 42C includes the first connection portion 61, the second connection portion 62, the extending portion 63, and the extension 64. The first connection portion 61 is electrically connected to the terminal 13B of the electronic component 10B via the connection component 20C that is the first connection component 20. The second connection portion 62 is electrically connected to another subunit SU via the coupling bus bar 75B. The extension 64 extends to the region R overlapping the electronic component 10B when viewed from the Z direction, and has an end 42e1 of the bus bar 42 at a position overlapping the electronic component 10B when viewed from the Z direction. The bus bar 42C is another example of a “second bus bar”. The bus bar 42C is, for example, a bus bar included in the negative electrode line NL included in the electrical connection unit 1. From another point of view, the bus bar 42C is an example of a “first bus bar”.

### (Fourth Routing Example)

Next, a routing example related to the bus bar 42D will be described. The bus bar 42D has the first connection portion 61, the second connection portion 62, and the extending portion 63. The first connection portion 61 is electrically connected to the terminal 13A of the electronic component 10B via the connection component 20D that is the first connection component 20. The second connection portion 62 is electrically connected to the terminal 13B of the electronic component 10C via the connection component 20E that is the second connection component 20. The bus bar 42D is another example of a “third bus bar”. The bus bar 42D is, for example, a bus bar included in the negative electrode line NL included in the electrical connection unit 1. From another point of view, the bus bar 42D is another example of a “second bus bar”.

### (Fifth Routing Example)

Next, a routing example related to the bus bar 42E will be described. The bus bar 42E has the first connection portion 61, the second connection portion 62, and the extending portion 63. The first connection portion 61 is electrically connected to the terminal 13A of the electronic component 10C via the connection component 20F that is the first connection component 20. The second connection portion 62 is electrically connected to the external connection bus bar 76B via the connection component 30B that is the second connection component 30. The bus bar 42E is another example of a “second bus bar”. The bus bar 42E is, for example, a bus bar included in the negative electrode line NL included in the electrical connection unit 1. From another point of view, the bus bar 42E is another example of a “third bus bar”.

In the present embodiment, for example, the bus bar 42C is connected to the positive electrode terminal of the electronic component 10, and the bus bar 42D is connected to the negative electrode terminal of the electronic component 10. In this case, the third bent portion 412b3 insulates the bus bar 42C and the bus bar 42D from each other. For example, the bus bar 42A is connected to the negative electrode terminal of the electronic component 10, and the bus bar 42E is connected to the positive electrode terminal of the electronic component 10. In this case, the bent portion 412b insulates bus bar 42A and bus bar 42E from each other.

### (Fastening Member)

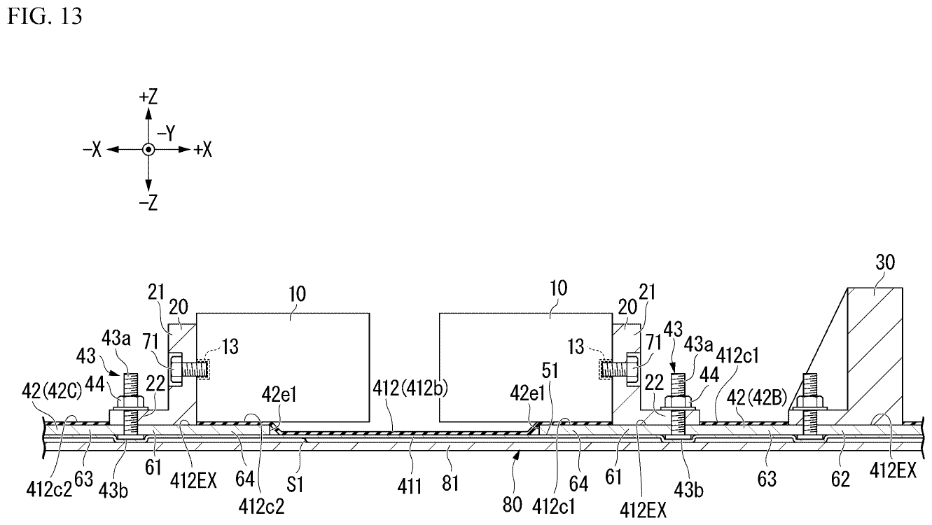

The fastening member 43 will be described with reference to FIG. 13. The fastening member 43 is a component for fixing the bus bar 42 to a connection target component (the connection component 20, the connection component 30, the coupling bus bar 75, or a connection component 100) of the bus bar 42. The fastening member 43 is, for example, a caulking bolt fixed to the bus bar 42. The fastening member 43 is an example of a “fastening portion”.

In the present embodiment, each of the first connection portion 61 and the second connection portion 62 of the bus bar 42 has a through-hole into which the fastening member 43 is inserted. The through-hole penetrates the bus bar 42 in the Z direction. The fastening member 43 is, for example, a bolt having a shaft 43a and a head 43b. A circumferential surface of the shaft 43a has a screw groove. The head 43b has a diameter larger than that of the shaft 43a. The head 43b of the fastening member 43 is caulked and fixed to the bus bar 42 in a state in which the shaft 43a passes through the through-hole of the bus bar 42. With this fixation, the fastening member 43 is electrically and physically connected to the bus bar 42 in a state in which the shaft 43a protrudes in the +Z direction from the through-hole of the bus bar 42. The fastening member 43 is not limited to caulking fixation, and may be fixed to the bus bar 42 through welding or other methods.

In the present embodiment, the head 43b is in contact with the first insulating member 411 in a state of being caulked and fixed to the bus bar 42. This prevents the bolt having the head 43b from falling off.

In the present embodiment, the connection component 20 is attached to the fastening member 43 from the Z direction in a state of being previously fixed to the electronic component 10 via the fastening member 72 or the fastening member 71. For example, in the connection component 20, the shaft portion 43a of the fastening member 43 is inserted into the second attachment hole 22h of the second portion 22. The engagement member 44 (for example, a nut) is engaged with the shaft portion 43a of the fastening member 43 protruding from the second attachment hole 22h of the second portion 22 of the connection component 20. The engagement member 44 is attached to the shaft 43a in the Z direction, for example. This engagement fixes the second portion 22 of the connection component 20 to the fastening member 43.

### <4. Plate>

FIG. 14 is an exploded perspective view illustrating the subunit with the subunit being disassembled from the plate 80. The plate 80 is a member for securing a rigidity of the electrical connection unit 1. The plate 80 is made of a resin or a metal (for example, aluminum or an aluminum alloy). The material of the plate 80 is selected as appropriate according to a method of fixing the routing board 40. The plate 80 may be referred to as a “rigid member”.

The plate 80 faces the routing board 40 along the Z direction and supports the routing board.

The plate 80 has a rectangular shape formed in the X direction when viewed from the Z direction. The plate 80 has a central portion 80e1, a second end 80e2, a third end 80e3, and a fourth end 80e4. The second end 80e2 is one end of the plate 80 in the longitudinal direction, and is separated from the central portion 80e1 in the X direction. The third end 80e3 and the fourth end 80e4 are a pair of ends of the plate 80 in the lateral direction, and are separated in the Y direction. The plate 80 includes, for example, a flat surface portion 81 provided along the horizontal direction, and reinforces the routing board 40. In addition, the flat surface portion 81 may be provided with one or more protrusions 82 or one or more through-holes as necessary. For example, the protrusion 82 or the through-hole may be provided in the flat surface portion 81 so as to correspond to the through-hole 52h penetrating the first insulating member 411 and the second insulating member 412 in the Z direction. In the present embodiment, the plate 80 has a plurality of protrusions 82 on the flat surface portion 81.

Which one of the protrusion 82 and the through-hole is adopted depends on a base material of the plate 80.

For example, when the plate 80 is made of a resin, the protrusion 82 is provided on the flat surface portion 81, so that the routing board 40 can be fixed through thermal caulking. By fixing the routing board 40 through thermal caulking, the number of components related to fixing of the routing board 40 can be reduced.

When the plate 80 is made of a metal, the through-hole is provided in the flat surface portion 81, and thus it is possible to fix the routing board 40 through mechanical joining using a fixing tool that presses the routing board 40 from the Z direction and a fastening member such as a screw or a bolt. When the plate 80 is made of a metal, the heat dissipation property of the electrical connection unit 1 is improved.

Similarly, there are two methods for fixing the electronic component 10M. For example, when the plate 80 is made of a resin and the protrusion 83 corresponding to the through-hole 51h is present, the electronic component 10M can be fixed through thermal caulking. When the plate 80 is made of a metal and a through-hole corresponding to the through-hole 51h is present, the electronic component 10M can be fixed by using a fastening member such as a screw or a bolt.

Further, the plate 80 may be made of a metal, and the protrusion 83 corresponding to the through-hole 51h may be present. In this case, the protrusion 83 may have an engagement hole with which a fastening member such as a screw or a bolt is engaged. An inner circumferential surface of the engagement hole of the protrusion 83 has a screw groove.

Similarly, the plate 80 may be made of a metal, and the protrusion 82 corresponding to the through-hole 52h may be present. In this case, the protrusion 82 may have an engagement hole with which a fastening member such as a screw or a bolt is engaged. An inner circumferential surface of the engagement hole of the protrusion 82 has a screw groove. In the present embodiment, the plate 80 has the protrusion 82 provided with an engagement hole and the protrusion 83 provided with an engagement hole.

The flat surface portion 81 is portion of the plate 80 that is formed in a plate shape. The flat surface portion 81 has a plate shape formed in the horizontal direction. The flat surface portion 81 forms a main portion of the plate 80. The flat surface portion 81 forms a base portion of the plate 80. In the present embodiment, the flat surface portion 81 has a size that covers the three subunits SU from below. The flat surface portion 81 faces the routing boards 40 of the three subunits SU.

### <5. Advantages>

As Comparative Example A, an electrical connection unit in which a bus bar is disposed in a standing posture with respect to a lower wall of a housing will be considered. In such a constitution of the comparative example, for example, since a cross-sectional area of a bus bar is determined in order to function as a routing member, it may be difficult to reduce a width (height) of the standing bus bar. In this case, the width of the standing bus bar becomes a bottleneck, and it may be difficult to reduce a height of the electrical connection unit.

On the other hand, in the present embodiment, the routing board 40 includes a first bus bar (bus bar 42A), a second bus bar (bus bar 42C), a first insulating member 411, and a second insulating member 412. At least part of the first bus bar (bus bar 42A) extends in a plate shape. The second bus bar (bus bar 42C) is located on the same plane as the first bus bar (bus bar 42A), and is disposed away from the first bus bar (bus bar 42A) in the first direction (X direction). At least part of the second bus bar (bus bar 42C) extends in a plate shape. The first insulating member 411 is in contact with the first bus bar (bus bar 42A) and the second bus bar (bus bar 42C) from the second direction (Z direction) intersecting the first direction (X direction). The second insulating member 412 is a sheet-shaped member, and includes a first cover portion (first cover portion 412c1), a second cover portion (second cover portion 412c2), and a first bent portion (first bent portion 412b1). The first cover portion (first cover portion 412cl) is in contact with the first bus bar (bus bar 42A) from the side opposite to the first insulating member 411. The second cover portion (second cover portion 412c2) is in contact with the second bus bar (bus bar 42C) from the side opposite to the first insulating member 411. The first bent portion (first bent portion 412b1) is bent from the first cover portion (first cover portion 412c1) and the second cover portion (second cover portion 412c2) toward the first insulating member 411 in a region between the first cover portion (first cover portion 412c1) and the second cover portion (second cover portion 412c2) and is joined to the first insulating member 411. According to such a constitution, compared with the structure of Comparative Example A in which at least part of the routing path is formed on a plane, the width of the bus bar is less likely to be a bottleneck, and the height of the electrical connection unit 1 can be easily reduced.

In addition, the second insulating member 412 has a function of preventing finger contact with the energization path of the routing board 40. Due to the presence of the second insulating member 412, a cover that covers the current path need not be provided.

In the present embodiment, the routing board 40 further includes a third bus bar (bus bar 42D). The third bus bar (bus bar 42D) is located on the side opposite to the first bus bar (bus bar 42A) with respect to the second bus bar (bus bar 42C) on the same plane as the first bus bar (bus bar 42A) and the second bus bar (bus bar 42C), is disposed away from the second bus bar (bus bar 42C) in the first direction (X direction), and at least partially extends in a plate shape. The first insulating member 411 is in contact with the third bus bar (bus bar 42D) from the second direction (Z direction). The second insulating member 412 further includes a third cover portion (third cover portion 412c3) and a second bent portion (second bent portion 412b2). The third cover portion (third cover portion 412c3) is in contact with the third bus bar (bus bar 42D) from the side opposite to the first insulating member 411. The second bent portion (second bent portion 412b2) is bent from the second cover portion (second cover portion 412c2) and the third cover portion (third cover portion 412c3) toward the first insulating member 411 in a region between the second cover portion (second cover portion 412c2) and the third cover portion (third cover portion 412c3) and is joined to the first insulating member 411. According to such a constitution, since more portions of the routing path are formed on a plane, it is further easy to reduce the height of the electrical connection unit 1.

In the present embodiment, in the routing board 40, the first bus bar (bus bar 42A) includes the first connection portion 61 electrically connected to the electronic component 10, an external device, or another bus bar, the second connection portion 62 electrically connected to an electronic component, an external device, or another bus bar, and a first extending portion (extending portion 63) extending between the first connection portion 61 and the second connection portion 62. The second bus bar includes a third connection portion (first connection portion 61) electrically connected to the electronic component 10, an external device, or another bus bar, a fourth connection portion (second connection portion 62) electrically connected to the electronic component 10, an external device, or another bus bar, and a second extending portion (extending portion 63) extending between the third connection portion (first connection portion 61) and the fourth connection portion (second connection portion 62). The first cover portion (first cover portion 412cl) covers the first extending portion (extending portion 63) and includes a first opening (opening 412EX) through which the first connection portion is exposed and a second opening (opening 412EX) through which the second connection portion 62 is exposed. The second cover portion (second cover portion 412c2) covers the second extending portion (extending portion 63) and includes a third opening (opening 412EX) through which the third connection portion (first connection portion 61) is exposed and a fourth opening (opening 412EX) through which the fourth connection portion is exposed.

According to such a constitution, in the routing board 40, electrical connection between each of the connection portions (the first connection portion 61 and the second connection portion 62) included in the bus bar 42 and the electronic component 10 and the like (including an external device and another bus bar) can be easily achieved by the opening 412EX.

In the present embodiment, a first fastening portion (fastening member 43), a second fastening portion (fastening member 43), a third fastening portion (fastening member 43), and a fourth fastening portion (fastening member 43) are further provided. The first fastening portion (fastening member 43) protrudes from the first connection portion 61 in the second direction (Z direction) through the first opening (opening 412EX). The second fastening portion (fastening member 43) protrudes from the second connection portion 62 in the second direction (Z direction) through the second opening (opening 412EX). The third fastening portion (fastening member 43) protrudes in the second direction (Z direction) from the third connection portion (first connection portion 61) through the third opening (opening 412EX). The fourth fastening portion (fastening member 43) protrudes in the second direction (Z direction) from the fourth connection portion (second connection portion 62) through the fourth opening (opening 412EX).

According to such a constitution, in the routing board 40, electrical connection between each of the connection portions (the first connection portion 61 and the second connection portion 62) included in the bus bar 42 and the electronic component 10 and the like (including an external device and another bus bar) can be easily achieved by the fastening member 43.

In the present embodiment, the electrical connection unit 1 includes the routing board 40 and the electronic component 10 electrically connected to the routing board 40. According to such a constitution, compared with the structure of the comparative example in which at least part of the routing path is formed on a plane, the width of the bus bar is less likely to be a bottleneck, and the height of the electrical connection unit 1 can be easily reduced.

As Comparative Example B, an electrical connection unit in which a bus bar is disposed in a standing posture with respect to a lower wall of a housing will be considered. In such a constitution of the comparative example, it is necessary to fix the bus bar to the housing in a standing posture, and it is difficult to improve workability regarding attachment of the bus bar. In this case, it may be difficult to improve the assemblability of the electrical connection unit 1.

On the other hand, in the present embodiment, in the electrical connection unit 1, the first bus bar (bus bar 42C) is connected to the positive electrode terminal (one of the terminal 13A and the terminal 13B) of the electronic component 10, and the second bus bar (bus bar 42D) is connected to the negative electrode terminal (the other of the terminal 13A and the terminal 13B) of the electronic component 10. The first bent portion (third bent portion 412b3) insulates the first bus bar (bus bar 42C) and the second bus bar (bus bar 42D) from each other.

According to such a constitution, in the electrical connection unit 1, the plurality of bus bars 42 can be easily handled integrally, and workability regarding attachment of the bus bars 42 can be improved compared with the constitution of Comparative Example B described above. Thus, the assemblability of the electrical connection unit 1 can be improved.

In the present embodiment, the electrical connection unit 1 can be connected between the first external device and the second external device. The first bus bar (bus bar 42A) is a bus bar included in the positive electrode line PL between the first external device and the second external device. The second bus bar (bus bar 42C) is a bus bar included in the negative electrode line NL between the first external device and the second external device. The first bent portion 412b1 insulates the first bus bar (bus bar 42A) and the second bus bar (bus bar 42C) from each other.

According to such a constitution, in the electrical connection unit 1, the plurality of bus bars 42 can be easily handled integrally, and workability regarding attachment of the bus bars 42 can be improved compared with the constitution of Comparative Example B described above. Thus, the assemblability of the electrical connection unit 1 can be improved.

In the present embodiment, the electrical connection unit 1 further includes a rigid member (plate 80) facing the routing board 40 in the second direction (Z direction) and supporting the routing board 40. According to such a constitution, the rigidity of the routing board 40 is easily secured.

### MODIFICATION EXAMPLES

Next, several modification examples will be described. Note that a constitution other than that described below in each modification example is the same as the constitution of the first embodiment.

### First Modification Example

A connection between the electronic component 10 and the bus bar 42 is not limited to the connection using the connection component 20. The electronic component 10 may be directly connected to the bus bar 42 by using a fastening member (for example, a bolt or a screw), welding, or the like.

### Second Modification Example

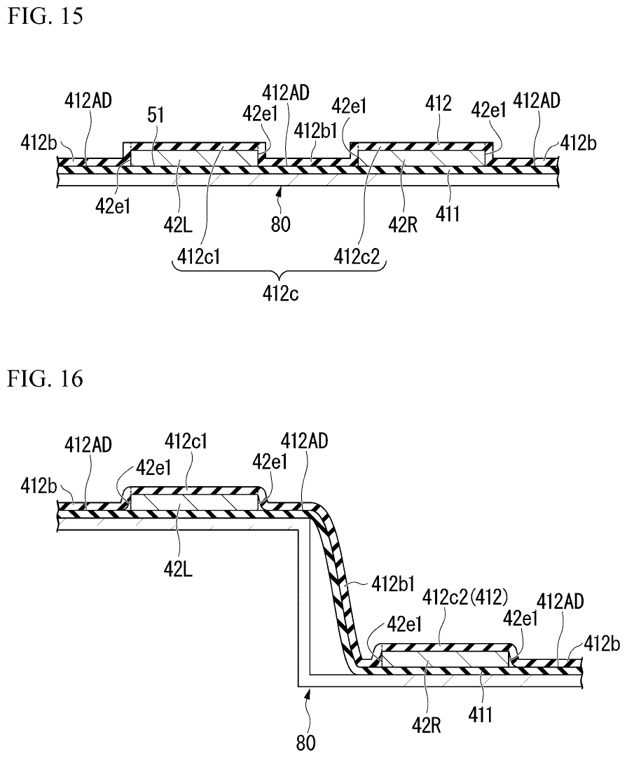

The bent portion 412b may have an outer shape following part of the side surface of the bus bar 42. As illustrated in FIG. 15, the first bent portion 412b1 has an outer shape that follows part of a side surface of a bus bar 42L located at the end 42e1. The first bent portion 412b1 has an outer shape that follows part of a side surface of a bus bar 42R located at the end 42el.

According to such a constitution, it is easy to restrict positions of the first bus bar (bus bar 42L) and the second bus bar (bus bar 42R) in the first direction (X direction). Therefore, the routing board 40 can easily ensure insulation between the bus bars 42.

### Third Modification Example

When the first insulating member 411 is a sheet-shaped member, the bent portion 412b of the routing board 40 may have bendable flexibility. As illustrated in FIG. 16, there is the plate 80 having a stepped surface between the first bus bar (bus bar 42L) and the second bus bar (bus bar 42R). The routing board 40 is placed on the plate 80. In this case, the first insulating member 411 and the second insulating member 412 are sheet-shaped members (insulating films). Therefore, the first bent portion 412b1 has bendable flexibility. The first bent portion 412b1 is placed while being bent along the stepped surface of the plate 80.

According to such a constitution, the routing board 40 is easily placed.

Several embodiments and modification examples have been described above. However, the embodiment and the modification examples are not limited to the examples described above. For example, a plurality of embodiments may be implemented in combination with each other. The above-described embodiments can be implemented in various other forms, and various additions, omissions, substitutions, and changes can be made without departing from the concept of the present disclosure.

### INDUSTRIAL APPLICABILITY

According to the present disclosure, the height of the electrical connection unit can be reduced.

### REFERENCE SIGNS LIST

1 Electrical connection unit
SU Subunit
10 Electronic component
13, 13A, 13B Terminal
20 Connection component
21 First portion
21h First attachment hole
22 Second portion
22h Second attachment hole
30 Connection component
31 First portion
32 Second portion
40 Routing board
41 Holding member
411 First insulating member
411EX Opening
412 Second insulating member
412EX Opening
42 Bus bar
42e1 End of bus bar
42p Plate portion
43 Fastening member (fastening portion)
51 Flat surface portion
51h Through-hole
52h Through-hole
61 First connection portion
62 Second connection portion
63 Extending portion
64 Extension
71 Fastening member
72 Fastening member
73 Fastening member
80 Plate
81 Flat surface portion
82 Protrusion
83 Protrusion
91 Insulating sheet
92 Heat transfer member

What is claimed is:

1. A routing board comprising:
a first bus bar at least part of which extends in a plate shape;
a second bus bar located on a same plane as the first bus bar, disposed away from the first bus bar in a first direction, and at least partially extending in a plate shape;
a first insulating member that is in contact with the first bus bar and the second bus bar from a second direction intersecting the first direction; and
a second insulating member that is a sheet-shaped member and that includes a first cover portion that is in contact with the first bus bar from a side opposite to the first insulating member, a second cover portion that is in contact with the second bus bar from the side opposite to the first insulating member, and a first bent portion that is bent from the first cover portion and the second cover portion toward the first insulating member in a region between the first cover portion and the second cover portion and is joined to the first insulating member.

2. The routing board according to claim 1, wherein
the first bent portion has an outer shape following part of a side surface of the first bus bar and part of a side surface of the second bus bar.

3. The routing board according to claim 1, wherein
the first insulating member is a sheet-shaped member, and
the routing board has flexibility such that a region between the first bus bar and the second bus bar is bendable.

4. The routing board according to claim 1, further comprising
a third bus bar located on a side opposite to the first bus bar with respect to the second bus bar on the same plane as the first bus bar and the second bus bar, disposed away from the second bus bar in the first direction, and at least partially extending in a plate shape,
wherein the first insulating member is in contact with the third bus bar from the second direction, and
the second insulating member further includes a third cover portion that is in contact with the third bus bar from the side opposite to the first insulating member, and a second bent portion that is bent from the second cover portion and the third cover portion toward the first insulating member in a region between the second cover portion and the third cover portion and is joined to the first insulating member.

5. The routing board according to claim 1, wherein
the first bus bar includes a first connection portion electrically connected to an electronic component, an external device, or another bus bar, a second connection portion electrically connected to an electronic component, an external device, or another bus bar, and a first extending portion extending between the first connection portion and the second connection portion,
the second bus bar includes a third connection portion electrically connected to an electronic component, an external device, or another bus bar, a fourth connection portion electrically connected to an electronic component, an external device, or another bus bar, and a second extending portion extending between the third connection portion and the fourth connection portion,
the first cover portion covers the first extending portion and includes a first opening through which the first connection portion is exposed and a second opening through which the second connection portion is exposed, and
the second cover portion covers the second extending portion and includes a third opening through which the third connection portion is exposed and a fourth opening through which the fourth connection portion is exposed.

6. The routing board according to claim 5, further comprising:
a first fastening portion protruding from the first connection portion in the second direction through the first opening;
a second fastening portion protruding from the second connection portion in the second direction through the second opening; and
a third fastening portion protruding from the third connection portion in the second direction through the third opening; and
a fourth fastening portion protruding from the fourth connection portion in the second direction through the fourth opening.

7. An electrical connection unit comprising:
the routing board according to claim 1; and
an electronic component electrically connected to the routing board.

8. The electrical connection unit according to claim 7, wherein
the first bus bar is connected to a positive electrode terminal of the electronic component,
the second bus bar is connected to a negative electrode terminal of the electronic component, and
the first bent portion insulates the first bus bar and the second bus bar from each other.

9. The electrical connection unit according to claim 7, wherein
the electrical connection unit is connectable between a first external device and a second external device,
the first bus bar is a bus bar included in a positive electrode line between the first external device and the second external device,
the second bus bar is a bus bar included in a negative electrode line between the first external device and the second external device, and
the first bent portion insulates the first bus bar and the second bus bar from each other.

10. The electrical connection unit according to claim 7, further comprising
a rigid member that faces the routing board in the second direction and supports the routing board.
